(19) United States
(12) Patent Application Publication
(10) Pub. No.: US 2018/0363937 A1
(43) Pub. Date: Dec. 20, 2018

(54) CONTROL APPARATUS, CONTROL METHOD, AND PROGRAM

(71) Applicant: SONY CORPORATION, TOKYO (JP)

(72) Inventor: HIDEO NAGASAKA, KANAGAWA (JP)

(21) Appl. No.: 16/063,017

(22) PCT Filed: Sep. 28, 2016
(86) PCT No.: PCT/JP2016/078679

§ 371 Date: Jun. 15, 2018

(30) Foreign Application Priority Data
Jan. 8, 2016 (JP) 2016-002201

(51) Int. Cl. F24F 11/63; F24F 11/61; F24F 11/526; G06F 15/18

(52) U.S. Cl. CPC F24F 11/63; F24F 11/61; F24F 2110/12; G06F 15/18; F24F 11/526

(57) ABSTRACT

[Object]To propose a control apparatus, control method and program which enable equipment to be controlled in a manner desirable for a user. [Solution]A control apparatus including: an inquiry unit configured to make an inquiry to a user as to control of equipment in a case where there is control information which is not uniquely determined in a control condition including a current environmental condition; and an equipment control unit configured to control the equipment in accordance with a response to the inquiry.

### TECHNICAL FIELD

The present disclosure relates to a control apparatus, a control method, and a program.

### BACKGROUND ART

In related art, a wide variety of techniques for automatically controlling various types of equipment such as, for example, cooling and heating equipment have been developed.

For example, Patent Literature 1 discloses a technique of learning relationship between an indoor temperature and an outdoor temperature, and a comfortable feeling input value when comfortable feeling is input by a user, finishing learning at a time point when 80% or more indicates “not uncomfortable” in a degree of comfortable feeling input, and automatically controlling cooling and heating equipment on the basis of a learning result.

### CITATION LIST

### Patent Literature

Patent Literature 1: JP 2000-291990A

### DISCLOSURE OF INVENTION

### Technical Problem

By the way, even if an indoor temperature and an outdoor temperature are respectively the same value, a method for controlling equipment desired by a user can vary. However, with the technique disclosed in Patent Literature 1, equipment is automatically controlled only using measurement values of the indoor temperature and the outdoor temperature. Therefore, there is a risk that the equipment may be controlled in a manner undesirable for the user.

Therefore, the present disclosure proposes a new and improved control apparatus, control method and program which enable equipment to be controlled in a manner desirable for a user.

### Solution to Problem

According to the present disclosure, there is provided a control apparatus including: an inquiry unit configured to make an inquiry to a user as to control of equipment in a case where there is control information which is not uniquely determined in a control condition including a current environmental condition; and an equipment control unit configured to control the equipment in accordance with a response to the inquiry.

In addition, according to the present disclosure, there is provided a control method including: making an inquiry to a user as to control of equipment in a case where there is control information which is not uniquely determined in a control condition including a current environmental condition; and controlling the equipment by a processor in accordance with a response to the inquiry.

In addition, according to the present disclosure, there is provided a program causing a computer to function as: an inquiry unit configured to make an inquiry to a user as to control of equipment in a case where there is control information which is not uniquely determined in a control condition including a current environmental condition; and an equipment control unit configured to control the equipment in accordance with a response to the inquiry.

### Advantageous Effects of Invention

As described above, according to the present disclosure, it is possible to control equipment in a manner desirable for a user. Note that the effect described here is not necessarily limiting, and any effects described in the present disclosure may be achieved.

### BRIEF DESCRIPTION OF DRAWINGS

FIG. 1 is an explanatory diagram illustrating a configuration example of a control system according to an embodiment of the present disclosure.

FIG. 2 is an explanatory diagram illustrating a configuration example of learning data 50 according to the embodiment.

FIG. 3 is a flowchart illustrating flow of processing according to a comparative example of the present disclosure.

FIG. 4 is a graph for explaining a problem according to the comparative example.

FIG. 5 is a functional block diagram illustrating a configuration example of a control apparatus 10 according to the embodiment.

FIG. 6 is a flowchart illustrating an operation example in a learning mode according to the embodiment.

FIG. 7 is a flowchart illustrating an operation example in an operation mode according to the embodiment.

FIG. 8 is an explanatory diagram illustrating a hardware configuration of the control apparatus 10 according to the embodiment.

### MODE(S) FOR CARRYING OUT THE INVENTION

Hereinafter, a preferred embodiment of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, there are also cases in which a plurality of structural elements that have substantially the same function and structure are distinguished by applying different alphabets after the same reference numerals in the specification and the drawings. For example, a plurality of components that have substantially the same function and structure are distinguished as a device 20a and a device 20b as needed. However, only the same reference numerals are applied in a case in which it is not particularly necessary to distinguish the plurality of respective structural elements that have substantially the same function and structure. For example, the device 20a and the device 20b are simply referred to as a device 20 in a case in which it is not particularly necessary to distinguish them.

Further, the “Mode(s) for Carrying Out the Invention” will be described in the following item order.
1. Configuration of control system
2. Detailed description of embodiment
3. Hardware configuration
4. Modification examples

### 1. CONFIGURATION OF CONTROL SYSTEM

### 1-1. System Configuration

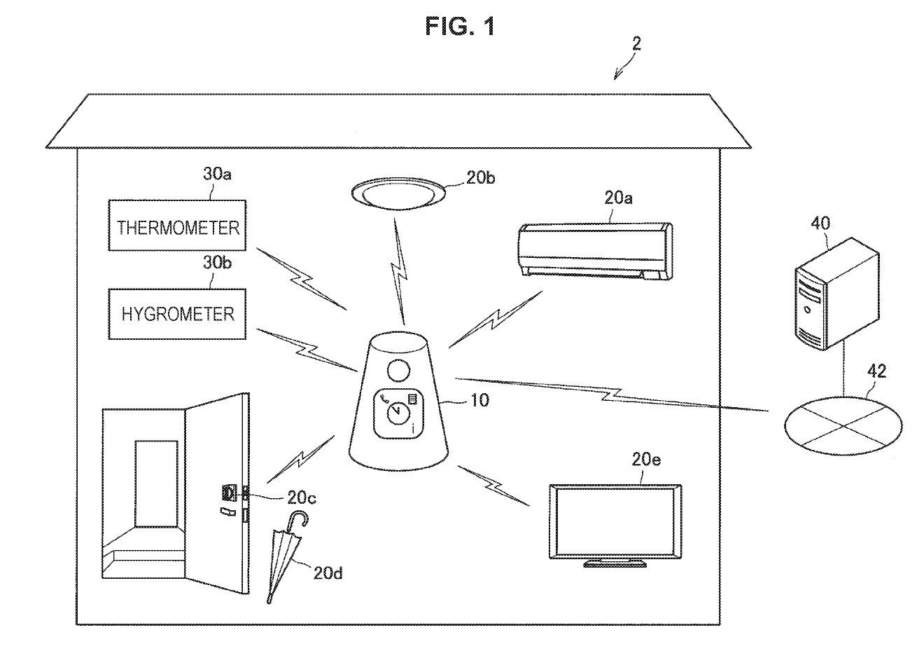

A basic configuration of a control system according to the present embodiment will be described first with reference to FIG. 1. As illustrated in FIG. 1, the control system according to the present embodiment includes a control apparatus 10, equipment 20, a sensor unit 30, a server 40 and a communication network 42.

### [1-1-1. Control Apparatus 10]

The control apparatus 10 is an apparatus for controlling operation of one or more items of equipment 20 provided within a predetermined facility 2. Here, the predetermined facility 2 is, for example, a house, a store, a factory, an office building, a public facility, or the like. For example, the control apparatus 10 controls operation of the equipment 20 so as to cause operation of the equipment 20 to be started or finished or cause setting information of the equipment 20 such as, for example, a set temperature and set humidity to be changed.

Further, the control apparatus 10 can communicate with the equipment 20 and the sensor unit 30 through wireless communication or wired communication. For example, the control apparatus 10 transmits a control signal for controlling operation of the equipment 20 to the equipment 20. Further, the control apparatus 10 receives a measurement result regarding an environmental condition from the sensor unit 30. Still further, the control apparatus 10 can be connected to the communication network 42 which will be described later. Here, the environmental condition is a condition determined by a value of at least one parameter. Further, a type of the parameter includes, for example, a temperature, humidity, weather, the number of users present in the facility 2, a time period of the user's stay in the facility 2, or the like.

Further, the control apparatus 10 can also control each equipment 20 on the basis of control information input by a user.

The control apparatus 10 is, for example, a portable apparatus. Further, the control apparatus 10 can be used by being disposed on a desk, floor, or the like. For example, the control apparatus 10 may be a dedicated apparatus as illustrated in FIG. 1. However, the present disclosure is not limited to such an example. The control apparatus 10 may be a mobile phone such as a smartphone, a tablet terminal, a personal computer (PC), a tabletop computer, game machine, or the like. Alternatively, the control apparatus 10 may be a wearable apparatus such as a head mount display and a wristwatch computer.

### [1-1-2. Equipment 20]

The equipment 20 is, for example, predetermined equipment disposed within the facility 2. For example, as illustrated in FIG. 1, the equipment 20 is an air conditioner 20a, lighting 20b, an electronic lock 20c, an umbrella 20d, a television receiver 20e, or the like. Alternatively, the equipment 20 may be an air purifier, a water heater, a refrigerator, acoustic equipment, a vacuum cleaner, a window, a blind, or the like.

For example, the equipment 20 can perform processing of changing a value of a specific parameter regarding an environmental condition, such as a temperature. Note that the equipment 20 may be provided in one room in the facility 2 or may be provided in a plurality of rooms.

### [1-1-3. Sensor Unit 30]

The sensor unit 30 performs measurement regarding the environmental condition. For example, the sensor unit 302 includes a plurality of types of sensors such as a thermometer, a hygrometer, a motion detector and an image sensor (camera). Note that an apparatus may be different for each type of sensor, or a plurality of types of sensors may be included in one apparatus. Further, a specific type of sensor may be integrally configured with the control apparatus 10 or any equipment 20 instead of being configured as an independent apparatus. For example, a thermometer 30a and a hygrometer 30b may be included in an air conditioner 20a.

Note that a plurality of types of sensors included in the sensor unit 30 may be provided in one room in the facility 2 or may be provided in a plurality of rooms. Alternatively, a specific type of sensor can be provided outdoors.

### [1-1-4. Server 40]

The server 40 is an apparatus which manages various kinds of information. For example, the server 40 learns correspondence relationship between values of a plurality of types of parameters and control information (control result) for the equipment 20 by the user and stores information of the learned correspondence relationship. Here, the control information for the equipment 20 by the user may be control information by the user himself/herself or may be control information by a plurality of users who utilize the facility. Alternatively, the control information may be control information by a plurality of users who are located in the same area as the facility, or may be control information by a plurality of users who are registered in, for example, predetermined service. Alternatively, the control information may be data prepared in advance by a manager. Alternatively, two or more types of data among the above-described five types of data may be mixed.

For example, the server 40 first receives values of a plurality of types of parameters in accordance with the measurement result by the sensor unit 30 upon input of control information for the equipment 20 and the input control information (control result) from the control apparatus 10. The server 40 then learns correspondence relationship between the values of the plurality of types of parameters and the control information by the user using the received data as learning data. For example, the server 40 learns the above-described correspondence relationship by using a publicly-known machine learning technique such as, for example, deep learning and the above-described learning data.

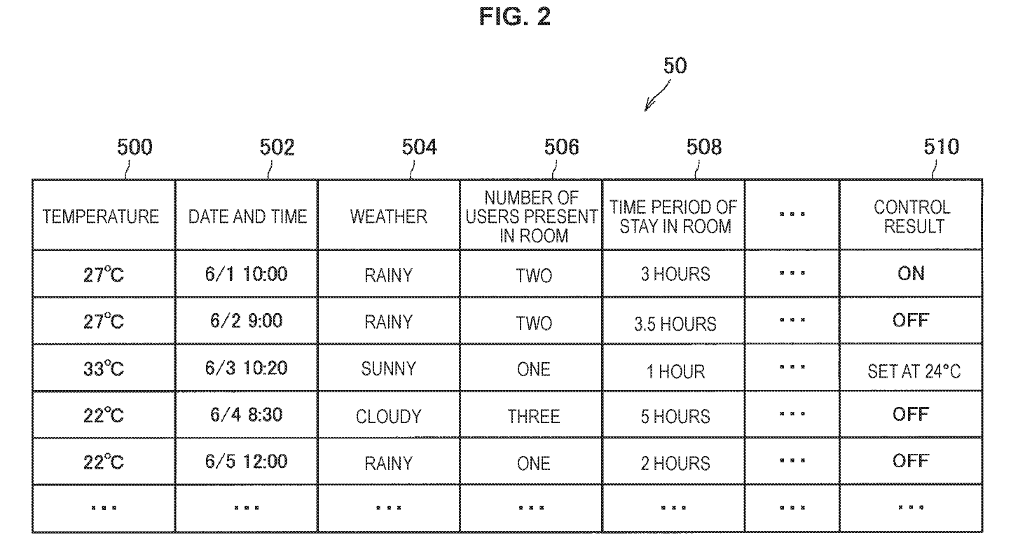

Here, an example of the learning data (learning data 50) will be described with reference to FIG. 2. As illustrated in FIG. 2, the learning data 50 includes, for example, a plurality of types of parameters such as a temperature 500, date and time 502, weather 504, the number of users present in a room 506 and a time period of stay in a room 508, and a control result 510. For example, a first record in FIG. 2, which is data when the user sets “ON” for the equipment 20, indicates that the temperature in the room is “27° C.”, the date and time is “6/1, 10:00”, the weather is “rainy”, the number of users in the room is “two”, and the time period of stay in the room is “three hours”.

### [1-1-5. Communication Network 42]

The communication network 42 is a wired or wireless transmission path of information transmitted from an apparatus connected to the communication network 42. For example, the communication network 42 may include a public network such as a telephone network, the Internet and a satellite communication network, various kinds of local area networks (LAN) including Ethernet (registered trademark), a wide area network (WAN), or the like. Further, the communication network 42 may include a leased line network such as Internet protocol-virtual private network (IP-VPN).

### 1-2. Comparative Example

The configuration of the control system according to the present embodiment has been described above. Here, to clearly show characteristics of the present disclosure, operation of a control apparatus 90 according to a comparative example of the present disclosure will be described. Note that an example will be described here where control information (control result) for the predetermined equipment 20 input by the user is one of “ON” and “OFF”.

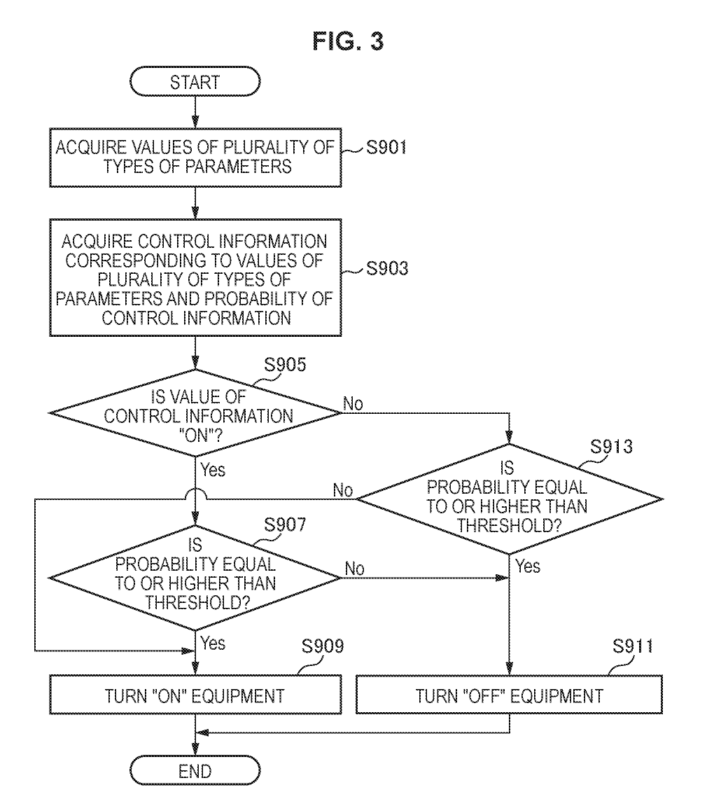

FIG. 3 is a flowchart illustrating a control method according to the present comparative example. As illustrated in FIG. 3, first, the control apparatus 90 acquires values of a plurality of types of parameters on the basis of reception of the measurement result by the sensor unit 30 (S901). Subsequently, the control apparatus 90 receives control information by the user, corresponding to the values of the plurality of types of parameters acquired in S901 and a probability indicating certainty of the control information from the server 40 (S903). Note that correspondence relationship between the values of the plurality of types of parameters and the control information by the user is determined in advance by the server 40 on the basis of the learning data.

Subsequently, the control apparatus 90 confirms whether or not a value of the received control information is “ON” (S905). In the case where the value of the control information is “ON” (S905: Yes), the control apparatus 90 then confirms whether or not the probability of the control information is equal to or higher than a threshold (S907). In the case where the probability is equal to or higher than the threshold (S907: Yes), the control apparatus 90 performs control to turn “ON” the target equipment 20 (S909). On the other hand, in the case where the probability is lower than the threshold (S907: No), the control apparatus 90 performs control to turn “OFF” (or not to turn “ON”) the target equipment 20 (S911).

Meanwhile, in the case where the value of the received control information is “OFF” (S905: No), the control apparatus 90 then confirms whether or not the probability of the control information is equal to or higher than a threshold (S913). In the case where the probability is equal to or higher than the threshold (S913: Yes), the control apparatus 90 performs processing in S911. On the other hand, in the case where the probability is lower than the threshold (S913: No), the control apparatus 90 performs processing in S909.

### 1-3. Organizing of Problems

As described above, in the present comparative example, in the case where the probability of the control information whose value is “ON” is lower than the threshold, the control apparatus 90 automatically performs control to turn “OFF” the target equipment 20.

By the way, typically, even in the case where values of a plurality of types of parameters regarding an environmental condition satisfies the same condition, control information input by the user can be different. For example, even if the respective values of the plurality of types of parameters are completely the same, there is a case where the user desires different control for the equipment 20 depending on a psychological state of the moment. Therefore, even if the values of the plurality of types of parameters are the same, control information (desired by the user) can be indeterminate.

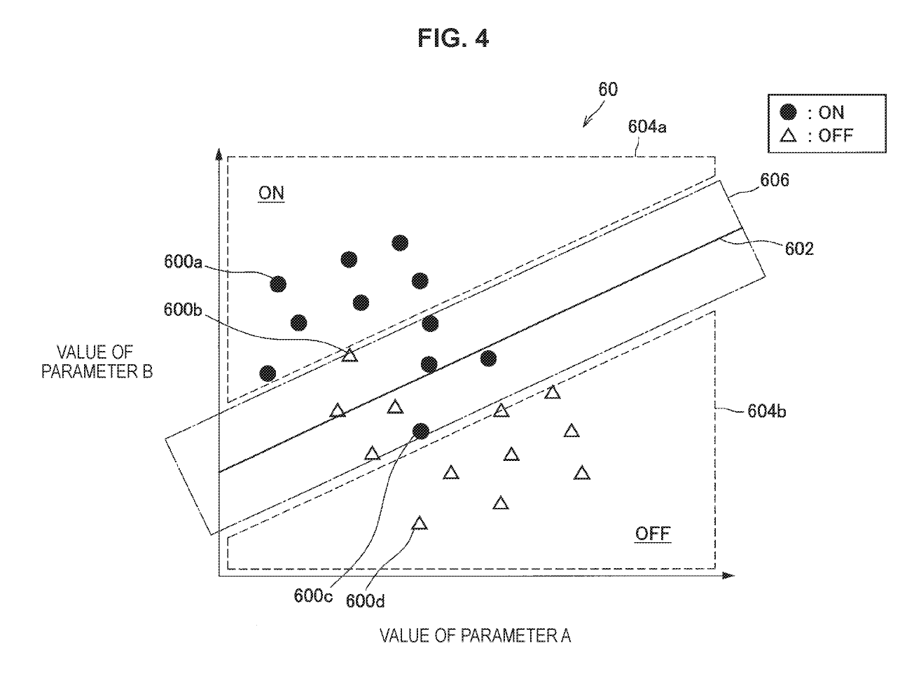

FIG. 4 is an example of a graph (graph 60) illustrating correspondence relationship between values of two types of parameters and a past control result 600 by the user. Note that FIG. 4 indicates a control result whose value is “ON” with a circle and indicates a control result whose value is “OFF” with a triangle. In the example illustrated in FIG. 4, in the case where combination of a value of a parameter A and a value of a parameter B is included in a range 604a illustrated in FIG. 4, a ratio of the control result whose value is “ON” is 100%. Further, in the case where combination of a value of the parameter A and a value of the parameter B is included in a range 604b illustrated in FIG. 4, a ratio of the control result whose value is “OFF” is 100%. Meanwhile, in a range 606 in the vicinity of a boundary 602, it is indeterminate whether the value of the control result is “ON” or “OFF”. For example, while a control result 600c illustrated in FIG. 4 is located closer to the range 604b than to the range 604a on the basis of the boundary 602, the value is “ON”. Further, while a control result 600b is located closer to the range 604a than to the range 604b on the basis of the boundary 602, the value is “OFF”.

However, in the present comparative example, the control apparatus 90 automatically determines a control method for the target equipment 20 only in accordance with whether or not the probability of the control information is equal to or higher than the threshold. For example, in the example illustrated in FIG. 4, the control apparatus 90 determines the control information (estimated to be desired by the user) as either “ON” or “OFF” in an automatic manner in accordance with the current value of the parameter A and the current value of the parameter B and the boundary 602, and automatically controls the equipment 20 in accordance with the judging result. Therefore, there is a possibility that control which is not desirable for the user may be performed.

Therefore, in view of the above-described circumstances, the control apparatus 10 according to the present embodiment has been made. According to the present embodiment, in the case where the control information (estimated to be desired by the user) is indeterminate, the control apparatus 10 can make an inquiry to the user as to control content of the equipment 20 and control the equipment 20 in accordance with a response to the inquiry. By this means, it is possible to control the equipment 20 in a manner desirable for the user.

### 2. DETAILED DESCRIPTION OF EMBODIMENT

### 2-1. Configuration

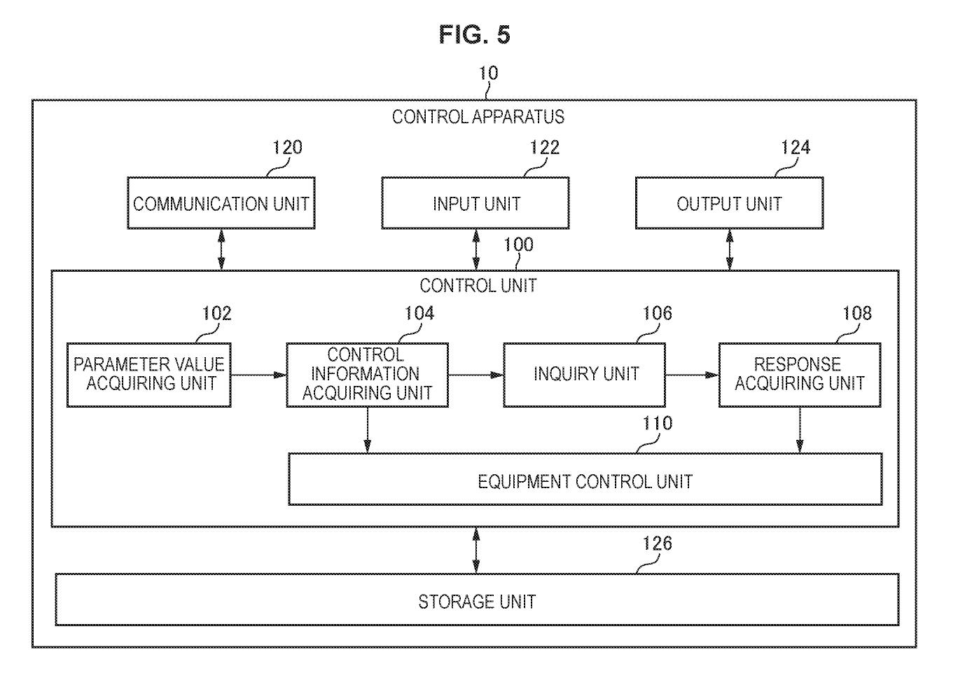

A configuration of the control apparatus 10 according to the present embodiment will be described in detail next. FIG. 5 is a functional block diagram illustrating the configuration of the control apparatus 10 according to the present embodiment. As illustrated in FIG. 5, the control apparatus 10 includes a control unit 100, a communication unit 120, an input unit 122, an output unit 124 and a storage unit 126.

[2-1-1. Control unit 100]

The control unit 100 generally controls operation of the control apparatus 10 using hardware such as a central processing unit (CPU) 150 and a random access memory (RAM) 154 which will be described later and which is incorporated into the control apparatus 10. For example, in the case where the number of pieces of learning data regarding correspondence relationship between the values of the plurality of types of parameters and the control information by the user reaches a predetermined number, the control unit 100 switches the control mode from a “learning mode” to an “operation mode”. Here, the learning mode is, for example, a mode in which the correspondence relationship between the values of the plurality of types of parameters and the control information by the user is continuously learned. Further, in the learning mode, basically, the control apparatus 10 does not allow the equipment 20 to automatically operate. Further, the operation mode is a mode in which the operation of the equipment 20 is controlled on the basis of the correspondence relationship learned in the learning mode.

Further, as illustrated in FIG. 5, the control unit 100 includes a parameter value acquiring unit 102, a control information acquiring unit 104, an inquiry unit 106, a response acquiring unit 108 and an equipment control unit 110.

### [2-1-2. Parameter Value Acquiring Unit 102]

### (2-1-2-1. Acquisition of Values of Parameters)

The parameter value acquiring unit 102 acquires a value of at least one parameter included in the environmental condition, for example, on the basis of the measurement result received from the sensor unit 30. For example, in the case where a current control mode is the learning mode, the parameter value acquiring unit 102 acquires values of a plurality of types of parameters upon acquisition of the control information by the user, for example, upon input of the control information to the input unit 122, or the like. Further, in the case where the current control mode is the operation mode, the parameter value acquiring unit 102 acquires a value of at least one parameter included in the current environmental condition.

For example, the parameter value acquiring unit 102 acquires measurement results such as a temperature and humidity received from the sensor unit 30 as the values of the parameters. Further, the parameter value acquiring unit 102 specifies the weather on the basis of the measurement results such as illuminance and rainfall received from the sensor unit 30 or weather forecast information at the date and time received from other apparatuses such as the server 40 and, then, acquires the specified result as the value of the parameter.

Further, the parameter value acquiring unit 102 specifies the number of users located within the facility or the time period of the users' stay in the facility on the basis of, for example, analysis of a captured image received from the sensor unit 30, a measurement result by a motion detector, or the like, and, then, acquires each respective specified result as the value of the parameter.

Further, the parameter value acquiring unit 102 can acquire a value of a specific type of parameter on the basis of information received from other apparatuses or information stored in the storage unit 126. For example, the parameter value acquiring unit 102 acquires schedule information of the user registered in other apparatuses or the storage unit 126 as the value of the parameter. Further, the parameter value acquiring unit 102 acquires weather forecast information received from other apparatuses as the value of the parameter.

### (2-1-2-2. Transmission of Values of Parameters)

Further, for example, in the case where the current control mode is the learning mode, the parameter value acquiring unit 102 causes the communication unit 120 to transmit the acquired values of the plurality of types of parameters to the server 40. Further, for example, in the case where the current control mode is the operation mode, the parameter value acquiring unit 102 transmits the acquired values of the plurality of types of parameters to the control information acquiring unit 104.

### [2-1-3. Control Information Acquiring Unit 104]

For example, in the case where the current control mode is the operation mode, the control information acquiring unit 104 receives control information by the user corresponding to the values of the plurality of types of parameters acquired by the parameter value acquiring unit 102, from, for example, the server 40. Note that, as described above, this correspondence relationship can be determined in advance on the basis of learning by the server 40.

### [2-1-4. Inquiry Unit 106]

### (2-1-4-1. Inquiry Condition)

The inquiry unit 106 makes an inquiry to the user as to control of the equipment 20 in the case where there is control information which is not uniquely determined in the control condition including the current environmental condition. For example, in the case where the control information acquired by the control information acquiring unit 104 is not unique, the inquiry unit 106 makes an inquiry to the user as to control of the equipment 20. Here, the control condition is a condition including, regarding at least one parameter, a value of the parameter included in the current environmental condition. For example, in the case where the type of the parameter includes the “temperature”, and a current “temperature” is “27.3° C.”, the control condition may be a condition such as “27° C. or higher and lower than 28° C.”. Further, in the case where the type of the parameter includes “humidity”, and the current “humidity” is “55%”, the control condition may be a condition such as “humidity of 50% or higher”. Alternatively, the control condition may be a condition that the values of the plurality of types of parameters are respectively the same as the values of the plurality of types of parameters included in the current environmental condition.

As an example, the inquiry unit 106 makes an inquiry to the user on the basis of comparison between the probability indicating certainty of the control information acquired by the control information acquiring unit 104 and a predetermined threshold. For example, in the case where the probability regarding the acquired control information is less than the predetermined threshold, the inquiry unit 106 makes an inquiry to the user. Further, in the case where the probability regarding the acquired control information is equal to or higher than the predetermined threshold, the inquiry unit 106 does not make an inquiry to the user. Here, the predetermined threshold may be 100%.

### (2-1-4-2. Content of Inquiry)

Further, for example, in the case where the equipment 20 is not operating, the inquiry unit 106 makes an inquiry as to whether or not to start operation of the equipment 20. Alternatively, in the case where the equipment 20 is operating, the inquiry unit 106 makes an inquiry to the user whether or not to stop operation of the equipment 20. Alternatively, the inquiry unit 106 makes an inquiry to the user as to a target value or an amount of change regarding one or more of the plurality of types of parameters.

For example, in the case where the target equipment 20 is the air conditioner 20a, the inquiry unit 106 makes an inquiry to the user as to “Shall I turn on the air conditioner?”, “At which temperature would you like to set the set temperature of the air conditioner?”, or the like. Further, in the case where the target equipment 20 is the electronic lock 20c, the inquiry unit 106 makes an inquiry to the user as to “Shall I unlock the door?”, “Shall I lock the door?”, or the like. Further, in the case where the target equipment 20 is the television receiver 20e, the inquiry unit 106 makes an inquiry to the user as to “Shall I turn on TV?”, “Shall I turn the channel of the TV to channel 10?”, or the like. Further, in the case where the target equipment 20 is the umbrella 20d, the inquiry unit 106 makes an inquiry to the user as to “Today's chance of precipitation is 50%. Would you need to take an umbrella with you?”, or the like. Note that the inquiry unit 106 can determine whether or not the umbrella 20d is held in the room (or whether or not the user has the umbrella 20d) on the basis of an analysis result of a captured image received from, for example, the sensor unit 30.

Further, the inquiry unit 106 makes an inquiry to the user by, for example, causing the output unit 124 to output sound of an inquiry message. Alternatively, the inquiry unit 106 makes an inquiry to the user by causing the output unit 124 to display an inquiry message, a user interface (UI) corresponding to content of the inquiry, or the like.

### [2-1-5. Response Acquiring Unit 108]

The response acquiring unit 108 acquires the response of the user to the inquiry by the inquiry unit 106. For example, the response acquiring unit 108 acquires the response on the basis of an analysis result of sound (of the response) emitted after the inquiry is made, text of the response input by the user, an option selected by the user among a select list of responses displayed on the display screen, or the like. Note that, in the case where sound of the response is input, the response acquiring unit 108 recognizes the input sound and, then, performs semantic analysis on the recognition result. Here, the response may be, for example, “Yes” or “No”, or may be “set the temperature at 24° C.”, or the like.

### [2-1-6. Equipment Control Unit 110]

The equipment control unit 110 controls the target equipment 20 in accordance with the control information acquired by the control information acquiring unit 104. For example, in the case where the probability regarding the control information acquired by the control information acquiring unit 104 is equal to or higher than a predetermined threshold, the equipment control unit 110 causes the communication unit 120 to transmit a control signal in accordance with the control information to the equipment 20. For example, in the case where the equipment 20 is the air conditioner 20a, control information whose value is “ON” is acquired, and the probability regarding the control information is equal to or higher than the predetermined threshold, the equipment control unit 110 causes the communication unit 120 to transmit a control signal for starting operation to the air conditioner 20a. According to this control example, in the case where the control information (estimated to be desired by the user) is determinate, the equipment is automatically controlled in accordance with the determinate control information. Therefore, it is possible to reduce labor of the user such as, for example, input of a response while realizing control desirable for the user.

Further, in the case where the probability regarding the control information acquired by the control information acquiring unit 104 is less than the predetermined threshold, the equipment control unit 110 controls the equipment 20 on the basis of the response acquired by the response acquiring unit 108. For example, in the case where the equipment 20 is the air conditioner 20a, and an analysis result of the sound of the response is “please set the temperature at 24° C.”, the equipment control unit 110 causes the communication unit 120 to transmit a control signal for setting the set temperature of the air conditioner 20a at 24° C. to the air conditioner 20a. According to this control example, in the case where the control information (estimated to be desired by the user) is indeterminate, because the equipment is controlled in accordance with content of the response of the user with respect to the inquiry, it is possible to control the equipment 20 in a manner desirable for the user.

### [2-1-7. Communication Unit 120]

The communication unit 120 transmits/receives information to/from other apparatuses which can communicate with the control apparatus 10. For example, the communication unit 120 receives a measurement result from the sensor unit 30. Further, the communication unit 120 transmits a control signal to the target equipment 20 in accordance with control by the equipment control unit 110.

### [2-1-8. Input Unit 122]

The input unit 122 accepts input by the user. For example, the input unit 122 accepts sound emitted by the user. Further, the input unit 122 includes an operating unit (illustration will be omitted) and accepts operation with respect to the operating unit. For example, the operating unit can include a touch panel, a button, a switch, a dial, or the like.

### [2-1-9. Output Unit 124]

The output unit 124 outputs sound or displays a display screen in accordance with control by, for example, the inquiry unit 106, or the like.

### [2-1-10. Storage Unit 126]

The storage unit 126 stores various kinds of data and various kinds of software.

### 2-2. Operation

The configuration according to the present embodiment has been described above. Operation according to the present embodiment will be described next in “2-2-1. Operation in learning mode” to “2-2-2. Operation in operation mode”.

### [2-2-1. Operation in Learning Mode]

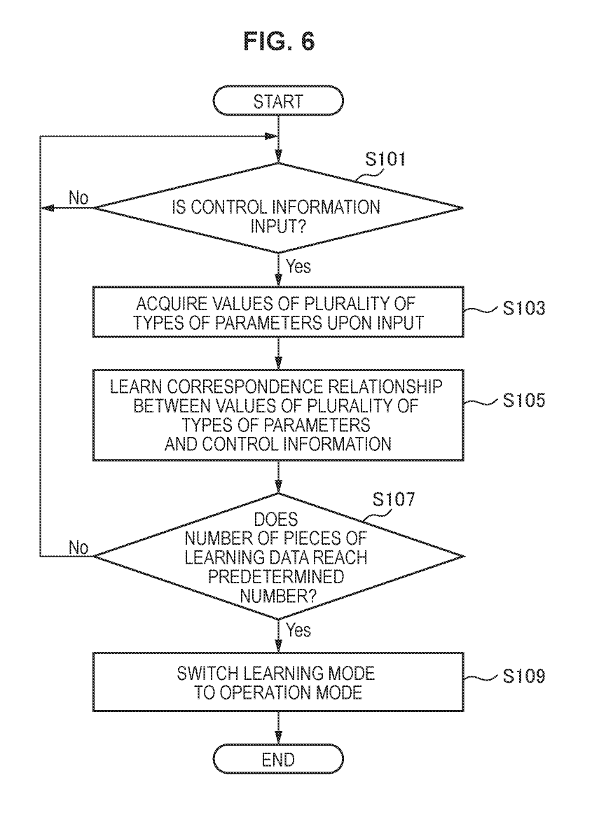

FIG. 6 is a flowchart illustrating an example of operation in the learning mode according to the present embodiment. As illustrated in FIG. 6, first, the control unit 100 determines whether or not some kind of control information with respect to the equipment 20 has been input by the user, for example, at predetermined time intervals (S101). Then, in the case where the control information has been input (S101: Yes), the parameter value acquiring unit 102 acquires values of a plurality of types of parameters by receiving measurement results measured by the sensor unit 30, for example, upon input of the control information (S103).

Subsequently, the parameter value acquiring unit 102 causes the communication unit 120 to transmit the acquired values of the plurality of types of parameters and the control information (control result) input in S101 to the server 40. Then, the server 40 learns correspondence relationship between the values of the plurality of types of parameters and the control information by the user using the received data as the learning data (S105).

Subsequently, the server 40 determines whether or not the number of pieces of the learning data reaches a predetermined number (S107). For example, the server 40 may determine whether or not the number of pieces of the learning data corresponding to the facility reaches the predetermined number or may determine whether or not the number of pieces of the learning data reaches the predetermined number for each equipment 20 disposed in the facility.

In the case where the number of pieces of the learning data does not reach the predetermined number (S107: No), the control unit 100 repeats the operation in S101 again. On the other hand, in the case where the number of pieces of the learning data reaches the predetermined number (S107: Yes), the control unit 100 switches the control mode from the “learning mode” to the “operation mode” (S109). Then, the present operation is finished.

### [2-2-2. Operation in Operation Mode]

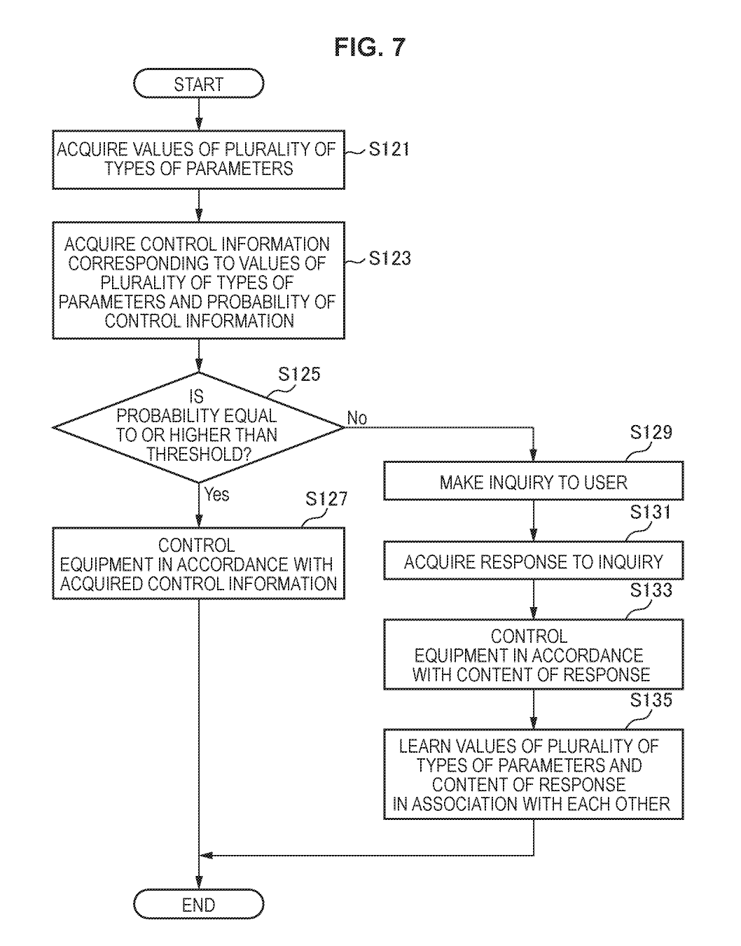

An example of operation in the operation mode according to the present embodiment will be described next with reference to FIG. 7. Note that, here, an operation example in a scene in which the target equipment 20 is turned “ON” or “OFF” will be described.

As illustrated in FIG. 7, first, the parameter value acquiring unit 102 of the control apparatus 10 acquires values of the plurality of types of parameters (included in the current environmental condition), for example, on the basis of information received from the sensor unit 30 (S121).

Subsequently, the control information acquiring unit 104 acquires control information by the user corresponding to the values of the plurality of types of parameters acquired in S121 and a probability indicating certainty of the control information from the server 40 (S123).

Subsequently, the inquiry unit 106 determines whether or not the probability regarding the control information acquired in S123 is equal to or higher than a predetermined threshold (S125). In the case where the probability regarding the control information is equal to or higher than the predetermined threshold (S125: Yes), the equipment control unit 110 controls the target equipment 20 in accordance with the acquired control information (S127). Then, the present operation is finished.

On the other hand, in the case where the probability regarding the control information is lower than the predetermined threshold (S125: No), the inquiry unit 106 makes an inquiry to the user as to control of the target equipment 20 (S129).

Subsequently, the user inputs a response to the input unit 122, for example, by emitting sound, performing touch operation, or the like. The response acquiring unit 108 acquires the input response (S131).

Subsequently, the equipment control unit 110 controls the equipment 20 in accordance with content of the acquired response (S133). For example, the equipment control unit 110 first generates a control signal for controlling the equipment 20 in accordance with the content of the acquired response. Then, the equipment control unit 110 causes the communication unit 120 to transmit the generated control signal to the equipment 20. Subsequently, the equipment 20 performs processing in accordance with the received control signal.

Subsequently, the control unit 100 transmits the values of the plurality of types of parameters acquired in S121 and the content of the response acquired in S131 to the server 40. The server 40 then further learns the correspondence relationship between the values of the plurality of types of parameters and the control information by the user using the received data as the learning data (S135). Then, the present operation is finished.

### 2-3. Effects

### [2-3-1. Effect 1]

As described above, the control apparatus 10 according to the present embodiment acquires the control information by the user corresponding to the control condition including the current environmental condition, then, makes an inquiry to the user as to control of the equipment 20 on the basis of the probability regarding the control information and, then, controls the equipment 20 in accordance with a response to the inquiry. For example, in the case where the probability regarding the control information is lower than the predetermined threshold, the control apparatus 10 makes an inquiry to the user and, then, controls the equipment 20 in accordance with a response to the inquiry.

Therefore, in the case where the control information (estimated to be desired by the user) is indeterminate in the control condition including the current environmental condition, the control apparatus 10 can control the equipment 20 in a manner desirable for the user.

### [2-3-2. Effect 2]

Further, according to the present embodiment, by utilizing current values of the plurality of types of parameters and the obtained response as new learning data, it is possible to further improve accuracy of the learning result. Therefore, it is possible to gradually decrease a case where the control information desired by the user is indeterminate, so that it is possible to prevent operation from being felt as erroneous operation during automatic operation of the equipment 20.

### [2-3-3. Effect 3]

Further, in the case where the probability regarding the acquired control operation is equal to or higher than the predetermined threshold, the control apparatus 10 controls the equipment 20 on the basis of the control information without making an inquiry to the user. Therefore, because an inquiry is not made to the user in the case where the control information (estimated to be desired by the user) is determinate in the control condition including the current environmental condition, it is possible to reduce labor of the user such as, for example, input of a response while realizing control desirable for the user.

### 3. HARDWARE CONFIGURATION

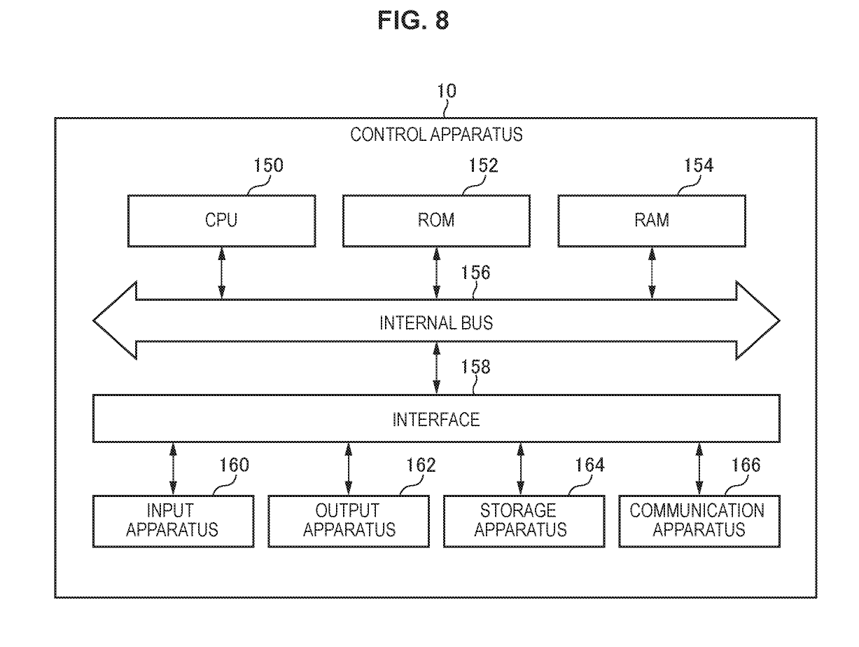

A hardware configuration of the control apparatus 10 according to the present embodiment will be described next with reference to FIG. 8. As illustrated in FIG. 8, the control apparatus 10 include a CPU 150, a read only memory (ROM) 152, a RAM 154, an internal bus 156, an interface 158, an input apparatus 160, an output apparatus 162, a storage apparatus 164 and a communication apparatus 166.

The CPU 150, which functions as an arithmetic processing unit and a control apparatus, controls the whole operation within the control apparatus 10 in accordance with various kinds of programs. Further, the CPU 150 implements a function of the control unit 100 at the control apparatus 10. Note that the CPU 150 includes a processor such as a microprocessor.

The ROM 152 stores programs, control data such as an operation parameter, or the like, to be used by the CPU 150.

The RAM 154 temporarily stores, for example, programs to be executed by the CPU 150.

The internal bus 156 includes a CPU bus, or the like. The internal bus 156 interconnects the CPU 150, the ROM 152 and the RAM 154.

The interface 158 connects the input apparatus 160, the output apparatus 162, the storage apparatus 164 and the communication apparatus 166 to the internal bus 156.

The input apparatus 160 includes, for example, input means for allowing the user to input information, such as a touch panel, a button, a switch, a dial and a microphone, an input control circuit which generates an input signal on the basis of input by the user and outputs the input signal to the CPU 150, or the like.

The output apparatus 162 includes a display apparatus such as, for example, a liquid crystal display (LCD) apparatus, an organic light emitting diode (OLED) apparatus and a lamp. Further, the output apparatus 162 includes a sound output apparatus such as a speaker.

The storage apparatus 164 is an apparatus for data storage, which functions as the storage unit 126. The storage apparatus 164 includes, for example, a storage medium, a recording apparatus which records data in the storage medium, a readout apparatus which reads out data from the storage medium, a deletion apparatus which deletes data recorded in the storage medium, or the like.

The communication apparatus 166 is a communication interface including a communication device, or the like, for connecting to, for example, the communication network 42, or the like. Further, the communication apparatus 166 may be a communication apparatus supporting a wireless LAN, a communication apparatus supporting long term evolution (LTE) or a wired communication apparatus which performs communication in a wired manner. The communication apparatus 166 functions as the communication unit 120.

### 4. MODIFICATION EXAMPLES

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

### 4-1. Modification Example 1

For example, while, in the above-described embodiment, an example has been mainly described where the inquiry unit 106 makes an inquiry in accordance with whether or not the probability regarding the control information acquired from the server 40 in the operation mode is lower than the predetermined threshold, the present disclosure is not limited to such an example. As a modification example, the inquiry unit 106 can also make an inquiry to the user with a probability in accordance with the probability regarding the acquired control information. For example, the inquiry unit 106 may make an inquiry to the user with a lower probability as the probability regarding the acquired control information is higher. As an example, in the case where the probability regarding the acquired control information is “90%”, the inquiry unit 106 may make an inquiry to the user with a probability of “1/5”, and, in the case where the probability regarding the control information is “95%”, the inquiry unit 106 may make an inquiry to the user with a probability of “1/10”.

According to this modification example, an inquiry is made with a lower probability as the probability regarding the acquired control information is higher. Therefore, it is possible to further reduce labor of the user such as, for example, input of a response while realizing control desirable for the user.

### 4-2. Modification Example 2

Further, while, in the above-described embodiment, an example has been described where the control apparatus 10 controls the equipment within the facility 2, the present disclosure is not limited to such an example. For example, the control apparatus 10 can be disposed inside a mobile body such as a vehicle, a ship and an airplane, and can control various kinds of equipment such as air-conditioning equipment provided inside the mobile body.

### 4-3. Modification Example 3

Further, while, in the above-described embodiment, an example has been described where the control apparatus in the present disclosure is the control apparatus 10, the present disclosure is not limited to such an example. For example, in the case where the server 40 includes all components included in the control unit 100, the control apparatus may be the server 40.

In addition, according to the aforementioned embodiments, it is also possible to provide a computer program for causing the hardware such as the CPU 150, the ROM 152, and the RAM 154 to exhibit functions that are equivalent to those of the respective components in the control apparatus 10 according to the aforementioned embodiments. In addition, a recording medium having the computer program recorded thereon is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A control apparatus including:

an inquiry unit configured to make an inquiry to a user as to control of equipment in a case where there is control information which is not uniquely determined in a control condition including a current environmental condition; and

an equipment control unit configured to control the equipment in accordance with a response to the inquiry.

(2)

The control apparatus according to (1),

in which the environmental condition includes a parameter, and

the control condition is a condition including, regarding the parameter, a value of the parameter included in the current environmental condition.

(3)

The control apparatus according to (2),

in which the environmental condition includes a plurality of types of parameters, and

the control condition is a condition including, regarding each of the plurality of types of parameters, the value of the parameter included in the current environmental condition.

(4)

The control apparatus according to (3),

in which the control condition is that values of the plurality of types of parameters are respectively the same as values of the plurality of types of parameters included in the current environmental condition.

(5)

The control apparatus according to any one of (2) to (4),

in which the parameter includes a temperature.

(6)

The control apparatus according to any one of (2) to (5),

in which the parameter includes humidity.

(7)

The control apparatus according to any one of (2) to (6),

in which the parameter includes date or time.

(8)

The control apparatus according to any one of (2) to (7),

in which the parameter includes weather.

(9)

The control apparatus according to any one of (2) to (8),

in which the parameter includes a number of users located within a predetermined facility.

(10)

The control apparatus according to any one of (2) to (9),

in which the parameter includes a time period of a user's stay in a predetermined facility.

(11)

The control apparatus according to any one of (1) to (10),

in which correspondence relationship between the control condition and the control information is determined on a basis of machine learning.

(12)

The control apparatus according to (11),

in which the correspondence relationship between the control condition and the control information is determined on a basis of a past control result of a user regarding the equipment.

(13)

The control apparatus according to any one of (1) to (12),

in which, in a case where the control information is uniquely determined in the control condition, the inquiry unit does not make the inquiry, and

the equipment control unit controls the equipment in accordance with the control information.

(14)

The control apparatus according to any one of (1) to (13),

in which the control information is information for starting or stopping the equipment.

(15)

The control apparatus according to any one of (1) to (13),

in which the environmental condition includes at least one parameter, and

the control information is a target value regarding the at least one parameter.

(16)

The control apparatus according to any one of (1) to (15),

in which the inquiry unit makes an inquiry to the user as to whether or not to start the equipment or whether or not to stop the equipment.

(17)

The control apparatus according to any one of (1) to (16),

in which the environmental condition includes at least one parameter, and the inquiry unit makes an inquiry to the user as to a target value regarding the at least one parameter.

(18)

The control apparatus according to any one of (1) to (17),

in which the inquiry unit makes an inquiry to the user through sound.

(19)

A control method including:

making an inquiry to a user as to control of equipment in a case where there is control information which is not uniquely determined in a control condition including a current environmental condition; and

controlling the equipment by a processor in accordance with a response to the inquiry.

(20)

A program causing a computer to function as:

an inquiry unit configured to make an inquiry to a user as to control of equipment in a case where there is control information which is not uniquely determined in a control condition including a current environmental condition; and

an equipment control unit configured to control the equipment in accordance with a response to the inquiry.

### REFERENCE SIGNS LIST

10, 90 control apparatus
20 equipment
30 sensor unit
40 server
42 communication network
100 control unit
102 parameter value acquiring unit
104 control information acquiring unit
106 inquiry unit
108 response acquiring unit
110 equipment control unit
120 communication unit
122 input unit
124 output unit
126 storage unit

1. A control apparatus comprising:
an inquiry unit configured to make an inquiry to a user as to control of equipment in a case where there is control information which is not uniquely determined in a control condition including a current environmental condition; and
an equipment control unit configured to control the equipment in accordance with a response to the inquiry.

2. The control apparatus according to claim 1,
wherein the environmental condition includes a parameter, and
the control condition is a condition including, regarding the parameter, a value of the parameter included in the current environmental condition.

3. The control apparatus according to claim 2,
wherein the environmental condition includes a plurality of types of parameters, and
the control condition is a condition including, regarding each of the plurality of types of parameters, the value of the parameter included in the current environmental condition.

4. The control apparatus according to claim 3,
wherein the control condition is that values of the plurality of types of parameters are respectively the same as values of the plurality of types of parameters included in the current environmental condition.

5. The control apparatus according to claim 2,
wherein the parameter includes a temperature.

6. The control apparatus according to claim 2,
wherein the parameter includes humidity.

7. The control apparatus according to claim 2,
wherein the parameter includes date or time.

8. The control apparatus according to claim 2,
wherein the parameter includes weather.

9. The control apparatus according to claim 2,
wherein the parameter includes a number of users located within a predetermined facility.

10. The control apparatus according to claim 2,
wherein the parameter includes a time period of a user's stay in a predetermined facility.

11. The control apparatus according to claim 1,
wherein correspondence relationship between the control condition and the control information is determined on a basis of machine learning.

12. The control apparatus according to claim 11,
wherein the correspondence relationship between the control condition and the control information is determined on a basis of a past control result of a user regarding the equipment.

13. The control apparatus according to claim 1,
wherein, in a case where the control information is uniquely determined in the control condition, the inquiry unit does not make the inquiry, and
the equipment control unit controls the equipment in accordance with the control information.

14. The control apparatus according to claim 1,
wherein the control information is information for starting or stopping the equipment.

15. The control apparatus according to claim 1,
wherein the environmental condition includes at least one parameter, and
the control information is a target value regarding the at least one parameter.

16. The control apparatus according to claim 1,
wherein the inquiry unit makes an inquiry to the user as to whether or not to start the equipment or whether or not to stop the equipment.

17. The control apparatus according to claim 1,
wherein the environmental condition includes at least one parameter, and
the inquiry unit makes an inquiry to the user as to a target value regarding the at least one parameter.

18. The control apparatus according to claim 1,
wherein the inquiry unit makes an inquiry to the user through sound.

19. A control method comprising:
making an inquiry to a user as to control of equipment in a case where there is control information which is not uniquely determined in a control condition including a current environmental condition; and
controlling the equipment by a processor in accordance with a response to the inquiry.

20. A program causing a computer to function as:
an inquiry unit configured to make an inquiry to a user as to control of equipment in a case where there is control information which is not uniquely determined in a control condition including a current environmental condition; and
an equipment control unit configured to control the equipment in accordance with a response to the inquiry.
